(19) United States
(12) Patent Application Publication
(10) Pub. No.: US 2026/0188684 A1
(43) Pub. Date: Jul. 2, 2026

(54) LITHIUM-ION SECONDARY BATTERY

(71) Applicant: ZHUHAI COSMX BATTERY CO., LTD., Zhuhai (CN)

(72) Inventors: Jiao Li, Zhuhai (CN); Jialin Fang, Zhuhai (CN)

(21) Appl. No.: 19/373,643

(22) Filed: Oct. 29, 2025

(30) Foreign Application Priority Data
Dec. 31, 2024 (CN) 202411995750.7

(51) Int. Cl. H01M 4/62; H01M 4/525; H01M 4/587; H01M 10/0525

(52) U.S. Cl. CPC H01M 4/628; H01M 4/525; H01M 4/587; H01M 10/0525

(57) ABSTRACT

A lithium-ion secondary battery comprises a positive electrode plate, a negative electrode plate, and an electrolyte, and has a charge cut-off voltage of ≥4.48 V. The positive electrode plate comprises a positive electrode active coating layer comprising lithium cobalt oxide, wherein the lithium cobalt oxide contains the element Al, and the mass content c1 of the element Al in the positive electrode active coating layer is 6000-15000 ppm. The negative electrode plate comprises a negative electrode active coating layer comprising a silicon-carbon material, wherein the mass content c2 of the element Si is 1.5-16%; and the silicon-carbon material comprises primary spherical particles with an average particle size of 1-6 μm. The electrolyte comprises 1,3,6-hexanetricarbonitrile, with the mass content c3 of 1,3,6-hexanetricarbonitrile in the electrolyte and the mass content c2 of the element Si in the negative electrode active coating layer satisfying: 0.63≤c2/c3≤15.

### CROSS-REFERENCE TO RELATED APPLICATIONS

The present application claims priority to Chinese Patent Application No. 202411995750.7, titled “LITHIUM-ION SECONDARY BATTERY,” filed on Dec. 31, 2024, the entire contents of which are incorporated herein by reference.

### TECHNICAL FIELD

The present disclosure relates to the technical field of batteries, in particular to a lithium-ion secondary battery.

### BACKGROUND ART

Lithium-ion batteries hold great potential for electronic devices, electric vehicles, etc. Current technology is dedicated to increasing the energy density of batteries. Silicon-based materials have a relatively high theoretical specific capacity (approximately 3600 mAh/g), which is much higher than the theoretical specific capacity of graphite materials (approximately 370 mAh/g). Therefore, the use of silicon-based materials as negative electrode active materials is considered a key solution for increasing the energy density of batteries. Meanwhile, it is necessary to improve the capacity utilization of the positive electrode to match the high theoretical specific capacity of the silicon-based materials. Therefore, using lithium cobalt oxide as a positive electrode active material and increasing the charge cut-off voltage of the battery is a relatively effective method to improve the capacity utilization of the positive electrode.

However, the lattice structure of lithium cobalt oxide will collapse at a high voltage (charge cut-off voltage ≥4.48 V), leading to poor cycling stability of the battery. Moreover, since silicon-based materials inherently have a low conductivity, the fast-charging capability of the battery is relatively poor when the negative electrode plate is doped with silicon.

Therefore, there is a need to improve both the cycling stability and fast-charging capability of high-energy-density batteries.

### SUMMARY OF THE INVENTION

An object of the present disclosure is to provide a lithium-ion secondary battery in order to overcome the problems of relatively poor cycling stability and fast-charging capability of high-energy-density batteries in the prior art. The lithium-ion secondary battery (hereinafter referred to as battery) of the present disclosure using a silicon-carbon material as a negative electrode active material and lithium cobalt oxide as a positive electrode active material can achieve a high energy density at a high charge cut-off voltage (for example, ≥4.48 V). Meanwhile, given the problem of low conductivity of a silicon-based material, the silicon-carbon material is improved in a way that the silicon-carbon material comprises primary spherical particles, and by adjusting and controlling the average particle size of the primary spherical particles, the conductivity of the silicon-carbon material is improved, thus improving the fast-charging capability of the battery. Moreover, by adjusting and controlling the content of the element Al in the lithium cobalt oxide, and the relationship between the content of the element Si and the content of 1,3,6-hexanetricarbonitrile in the electrolyte, the lattice structure of lithium cobalt oxide can be stabilized, thereby improving the cycling stability of the battery.

The present disclosure provides a lithium-ion secondary battery. The lithium-ion secondary battery comprises a positive electrode plate, a negative electrode plate, and an electrolyte, wherein the lithium-ion secondary battery has a charge cut-off voltage of ≥4.48 V; the positive electrode plate comprises a positive electrode active coating layer, the positive electrode active coating layer comprises a positive electrode active material, the positive electrode active material comprises lithium cobalt oxide, and the lithium cobalt oxide contains the element Al, with the mass content c1 of the element Al in the positive electrode active coating layer being 6000-15000 ppm; the negative electrode plate comprises a negative electrode active coating layer, the negative electrode active coating layer comprises a negative electrode active material, and the negative electrode active material comprises a silicon-carbon material, wherein the mass content c2 of the element Si in the negative electrode active coating layer is 1.5-16%; and the silicon-carbon material comprises primary spherical particles with an average particle size of 1-6 μm; and the electrolyte comprises 1,3,6-hexanetricarbonitrile, with the mass content c3 of 1,3,6-hexanetricarbonitrile in the electrolyte and the mass content c2 of the element Si in the negative electrode active coating layer satisfying: 0.63≤c2/c3≤15.

Conventionally used silicon-carbon materials are blocky, with an average particle size of about 6-12 μm. A relatively large average particle size leads to a relatively poor conductivity of the particles. In addition, since the hardness of the silicon-carbon material is relatively high, the compaction density thereof is relatively small, which makes it difficult to match the energy density requirements of the system where the silicon content in the negative electrode active coating layer reaches 5% or more, that is, the improvement of the energy density of the battery is limited. Using the silicon-carbon material of primary spherical particles with an average particle size of 1-6 μm not only leads to a relatively high silicon content, i.e., a silicon content up to 1.5-16% in the negative electrode active coating layer, but can also significantly improve the energy density of the battery; moreover, the particle size thereof is relatively small, which can improve the overall conductivity of the negative electrode plate, thus improving the charging speed of the battery.

With the increase of the upper limit of the charging voltage of the battery, the potential on the positive electrode side also becomes higher and higher, and thus, the challenge to the stability of the lattice structure of lithium cobalt oxide becomes greater. On the one hand, the element Al is capable of forming an Al—O bond, which has a relatively large bond energy, with the element O in lithium cobalt oxide, thus effectively suppressing the lattice oxygen from escaping; on the other hand, Al³⁺ is more stable in the octahedral structure of lithium cobalt oxide, which makes it more difficult for lithium cobalt oxide to transform into a monoclinic system, thus reducing the kinetics of the formation of the monoclinic system and inhibiting the phase transition of lithium cobalt oxide. Therefore, the effect of stabilizing lithium cobalt oxide can be achieved by adjusting the mass content of the element Al in the positive electrode active coating layer. However, it does not mean that the greater the content of the element Al, the better. This is because when the content of the element Al increases, the gram capacity of lithium cobalt oxide decreases, which will affect the overall energy density of the battery. Therefore, it is necessary to adjust the mass content of the element Al in the positive electrode active coating layer, such that when a specific range is met, stable operation of the positive electrode plate under a high voltage (e.g., 4.48 V or higher) can be ensured, and sufficient capacity utilization of the positive electrode plate is ensured, while loss in energy density caused by an excessively high mass content of the element Al is avoided.

By means of the above solution, the fast-charging capability of the battery can be improved, and the cycling stability of the battery can be improved to some extent. However, the improvement in the cycling stability is not as expected. Therefore, the cycling stability of the battery needs to be further improved. The cyano functional group (C≡N) in the molecular structure of 1,3,6-hexanetricarbonitrile can complex with the transition metal ions dissolved from the positive electrode plate, forming a stable CEI (Cathode Electrolyte Interphase) membrane on the surface of the positive electrode plate. Therefore, the addition of a nitrile additive to the electrolyte can reduce the risk of metal ion dissolution, electrolyte decomposition and corrosion of the positive electrode plate by hydrogen fluoride as a side reaction product at a high voltage, thus further protecting the lattice structure of lithium cobalt oxide to a certain extent. Furthermore, the inventors of the present disclosure have found through extensive targeted studies that the direct cause of the poor stability of lithium cobalt oxide at a high voltage lies in the silicon-carbon material in the negative electrode plate. This is because during the charge-discharge cycling of the battery, the silicon-carbon material undergoes volume expansion/contraction, leading to continuous cracking and re-formation of the SEI (Solid Electrolyte Interphase) membrane on the surface of the negative electrode plate. This process persistently consumes the active lithium in the battery. With the persistent consumption of active lithium, lithium ions cannot return to the lattice structure of lithium cobalt oxide, resulting in a continuous decrease in the amount of lithium in the lattice structure of lithium cobalt oxide, and the structure collapse cannot be prevented even by adjusting and controlling the content of the element Al. That is to say, as the mass content of the element Si in the negative electrode active coating layer increases, the consumption of active lithium intensifies, and the collapse of the lithium cobalt oxide lattice also worsens. Therefore, it is necessary to adjust and control both the mass content of the nitrile additive in the electrolyte and the mass content of the element Si in the negative electrode active coating layer. When the two satisfy a specific relationship, the content of the nitrile additive in the electrolyte simultaneously increases/decreases as the mass content of the element Si increases/decreases. In both cases, the structural stability of the positive electrode plate can be effectively enhanced. When c2/c3 is small (e.g., less than 0.63), the mass content of the nitrile additive is higher than that of the element Si, in which case the excess nitrile additive not only fails to protect the positive electrode but also causes damage to the negative electrode plate. When c2/c3 is high (e.g., greater than 15), the mass content of the nitrile additive is lower than that of the element Si, in which case the nitrile additive cannot effectively protect the positive electrode, leading to reduced cycling stability of the battery.

By means of the above technical solution, the present disclosure has at least the following advantages over the prior art: the battery of the present disclosure can have a high energy density, excellent cycling stability, and fast-charging capability.

The endpoints of ranges and any values disclosed herein are not limited to such exact ranges or values, and these ranges or values should be understood to include values close to these ranges or values. For numerical value ranges, one or more new numerical value ranges can be obtained between endpoint values of various ranges, between endpoint values of various ranges and individual point values, and between individual point values, and these numerical value ranges should be regarded as specifically disclosed herein.

### BRIEF DESCRIPTION OF THE DRAWINGS

FIG. 1 shows a schematic view (top view) of grooves on a surface of a negative electrode plate in an example of the present disclosure, where in FIG. 1(a), the grooves are arranged continuously; and in FIG. 1(b), the grooves are arranged in segments.

FIG. 2 shows a schematic view of the spacing of grooves in an example of the present disclosure, where FIG. 2(a) shows the case where two adjacent long sides are straight and parallel, FIG. 2(b) shows the case where two adjacent long sides are straight and non-parallel, and FIG. 2(c) shows the case where two adjacent long sides are curved.

FIG. 3 shows a schematic view of the width of grooves in an example of the present disclosure, where in FIGS. 3(a)-3(c), two long sides of the groove are straight lines, and in FIG. 3(d), two long sides of the groove are curved lines.

FIG. 4 shows a schematic view of the structure of a jelly roll in an example of the present disclosure.

FIG. 5 shows a schematic view of the structure of a positive electrode plate in an example of the present disclosure, where FIG. 5(a) is a top view, and FIG. 5(b) is a cross-sectional view along the thickness direction.

FIG. 6 shows a schematic top view of a first surface of a positive electrode plate in an example of the present disclosure.

### DETAILED DESCRIPTION OF EMBODIMENTS

Hereinafter, specific embodiments of the present disclosure will be described in detail. It should be understood that the specific embodiments described herein are only used to illustrate and explain the present disclosure and are not used to limit the present disclosure.

The present disclosure provides a lithium-ion secondary battery. The lithium-ion secondary battery can comprise a positive electrode plate, a negative electrode plate, and an electrolyte. The lithium-ion secondary battery has a charge cut-off voltage of ≥4.48 V, e.g., 4.48 V, 4.5 V or 4.53 V. The term charge cut-off voltage has the conventional meaning in the art and generally refers to the maximum voltage that a battery can safely reach during charging.

In the present disclosure, the positive electrode plate can comprise a positive electrode active coating layer. The positive electrode active coating layer can comprise a positive electrode active material, and the positive electrode active material can comprise lithium cobalt oxide. The lithium cobalt oxide comprises the element Al, with the mass content c1 of the element Al in the positive electrode active coating layer being 6000-15000 ppm, e.g., 6000 ppm, 7000 ppm, 8000 ppm, 9000 ppm, 10000 ppm, 11000 ppm, 12000 ppm, 13000 ppm, 14000 ppm, or 15000 ppm.

In an embodiment, c1 is 6500-12000 ppm.

In the present disclosure, the mass content c1 of the element Al in the positive electrode active coating layer can be determined by testing with a conventional method in the art, e.g., by using an inductively coupled plasma-optical emission spectrometer (ICP-OES), and the specific test method is as follows: a battery is discharged to 0% SOC and disassembled to take out a positive electrode plate; the positive electrode plate is soaked in the solvent dimethyl carbonate (DMC) for 12 h; and the positive electrode plate is then rinsed with the solvent DMC to remove a lithium salt adhered thereto and calcined in a muffle furnace at 400° C. for 3 h, the positive electrode active coating layer is then gently scraped off the surface of the positive electrode current collector, and the mass content (in ppm, i.e., parts per million) of the element Al is measured by ICP-OES. The specific operation method is carried out according to GB/T 30902-2014.

In the present disclosure, the chemical formula of the lithium cobalt oxide may be Li_{d}CoₑM³_{f}O₂, where 0.8≤d≤1.05, 0.85≤e<1, 0<f≤0.15, and M³ includes at least one of Al, Mg, Ti, Y, La, Ga, Ge, Sn, Si, Zr, Ca, Sb, In, Ni, and Mn. The lithium cobalt oxide can comprise first particles and second particles, wherein the average particle size of the first particles can be 0.3-7 μm (e.g., 0.3 μm, 0.5 μm, 1 μm, 2 μm, 3 μm, 4μ, 5 μm, 6 μm, or 7 μm), and the average particle size of the second particles can be 7.5-40 μm (e.g., 7.5 μm, 10 μm, 15 μm, 20 μm, 25 μm, 30 μm, 35 μm, or 40 μm). Using the lithium cobalt oxide comprising the first particles and second particles with different average particle sizes and controlling the difference of particle size distribution therebetween can directly affect the filling effect of lithium cobalt oxide powder in the process of compression, which in turn affects the compaction density and electron conductivity of the lithium cobalt oxide, thus facilitating the improvement of the overall energy density and fast-charging capability of the battery.

In the present disclosure, the average particle size of the first particles and the average particle size of the second particles can be determined by testing with a conventional method in the art. For example, a battery is discharged to 0% SOC and then disassembled to take out a positive electrode plate; the positive electrode plate is soaked in the solvent DMC for 12 h and then rinsed with the solvent DMC to remove a lithium salt adhered thereto and calcined in a muffle furnace at 400° C. for 3 h; and the positive electrode active coating layer is gently scraped off the surface of the positive electrode current collector and tested using a laser particle analyzer, and the particle size ranges of the first particles and the second particles can be derived from the resulting curves.

In the present disclosure, the negative electrode plate can comprise a negative electrode active coating layer. The negative electrode active coating layer can comprise a negative electrode active material, and the negative electrode active material can comprise a silicon-carbon material. The silicon-carbon material refers to a composite material comprising the element carbon and the element silicon, including, for example, a material formed by filling (including partially filling or completely filling) pores of porous carbon with silicon or partially oxidized silicon.

In the present disclosure, the mass content c2 of the element Si in the negative electrode active coating layer may be 1.5-16%, e.g., 1.5%, 2%, 3%, 4%, 5%, 6%, 7%, 8%, 9%, 10%, 11%, 12%, 13%, 14%, 15%, or 16%.

In an embodiment, c2 is 3-11%.

In the present disclosure, the mass content c2 of the element Si in the negative electrode active coating layer can be determined by testing with a conventional method in the art. For example, a battery is discharged to 0% SOC and then disassembled to take out a negative electrode plate; the negative electrode plate is soaked in the solvent DMC for 12 h and then rinsed with the solvent DMC to remove a lithium salt adhered thereto and dried in the air, and the negative electrode plate is then treated at a high temperature of 400° C. in an inert atmosphere for 2 h (for example, in a tube furnace in a nitrogen or argon atmosphere); and the negative electrode active coating layer can thus be gently scraped off the negative electrode current collector, and the negative electrode active coating layer is collected as a test sample. Using a thermogravimetric analyzer (e.g., TGA 550 thermogravimetric analyzer), an amount of 5-15 mg of the test sample is heated from room temperature (25° C.) to 900° C. at a ramp rate of 10° C./min in an air or oxygen atmosphere and maintained at 900° C. for 40 min, so that silicon can be fully oxidized into silicon dioxide while the non-silicon components in the negative electrode active coating layer can be volatilized. The residual substance is namely the ash of the negative electrode active coating layer. The mass content of the element Si in the negative electrode active coating layer can be calculated based on the mass of the ash, and the calculation formula is as follows: the mass content of the element Si in the negative electrode active coating layer=7×the mass of the ash/(15×the mass of the test sample).

In the present disclosure, the mass content of the element Si in the silicon-carbon material can be 30-80%, e.g., 30%, 35%, 40%, 45%, 50%, 55%, 60%, 65%, 70%, 75%, or 80%.

In the present disclosure, the silicon-carbon material can comprise primary spherical particles. The average particle size of the primary spherical particles can be 1-6 μm, e.g., 1 μm, 2 μm, 3 μm, 4 μm, 5 μm, or 6 μm.

In one example, the average particle size of the primary spherical particles is 3-5 μm.

In the present disclosure, the average particle size of the primary spherical particles can be determined by testing with a conventional method in the art. For example, a battery is discharged to 0% SOC and then disassembled to take out a negative electrode plate; the negative electrode plate is soaked in the solvent DMC for 12 h and then rinsed with the solvent DMC to remove a lithium salt adhered thereto and cut by argon ion grinder CP laser and then observed by SEM (using a high-voltage mode (Back-scattered Electrons BSE)), wherein in this mode, the contrast of the silicon-carbon material is bright (which can be used to distinguish the graphite material and the conductive agent in the negative electrode active coating layer); and after measurement at a magnification of 5K, at least 20 primary spherical particles are randomly selected to measure the particle size of each primary spherical particle, and the average value is taken. If the number of primary spherical particles is less than 20 at the magnification of 5K, another microscope image is taken until the 20 primary spherical particles are measured.

In the present disclosure, the electrolyte may comprise 1,3,6-hexanetricarbonitrile (HTCN).

In the present disclosure, the mass content c3 of HTCN in the electrolyte and the mass content c2 of the element Si in the negative electrode active coating layer satisfy: 0.63≤c2/c3 ≤15, e.g., 0.63, 1, 2, 3, 4, 5, 6, 7, 8, 9, 10, 11, 12, 13, 14, or 15.

In an embodiment, 1≤c2/c3≤7.4.

In an embodiment, 2≤c2/c3≤4.

In the present disclosure, the mass content c3 of HTCN in the electrolyte may be 0.5-5%, e.g., 0.5%, 1%, 2%, 3%, 4%, or 5%.

In the present disclosure, the mass content c3 of HTCN in the electrolyte can be determined by testing with a conventional method in the art, for example, by gas chromatography (GC).

In the present disclosure, the electrolyte may further comprises other nitrile additives, including, for example, at least one of acetonitrile, propionitrile, butyronitrile, succinonitrile, malononitrile, glutaronitrile, adiponitrile, pimelonitrile, suberonitrile, sebaconitrile, 1,2-bis(2-cyanoethoxy) ethane, 1,3,5-pentanetricarbonitrile, 1,2,3-propanetricarbonitrile, 1,2,6-hexanetricarbonitrile, 1,2,3-tris(2-cyanoethoxy) propane, 1,2,4-tris(2-cyanoethoxy) butane, 1,1,1-tris(cyanoethoxymethylene) ethane, 1,1,1-tris(cyanoethoxymethylene) propane, 3-methyl-1,3,5-tris(cyanoethoxy) pentane, 1,2,7-tris(cyanoethoxy) heptane, 1,2,6-tris(cyanoethoxy) hexane, 1,2,5-tris(cyanoethoxy) pentane, ethylene glycol bis(propionitrile) ether, hexafluorocyclotriphosphazene, pentafluoroethoxycyclotriphosphazene, pentafluorophenoxycyclotriphosphazene, 1,4-dicyano-2-butene, p-fluorobenzonitrile, p-methylbenzonitrile, 2-fluoroadiponitrile, 2,2-difluorosuccinonitrile, 1,5-dicyanopentane, 1,6-dicyanohexane, 1,7-dicyanoheptane, 1,8-dicyanooctane, 1,9-dicyanononane, 1,10-dicyanodecane, 1,12-dicyanododecane, 2,2,4,4-tetramethylglutaronitrile, 1,4-dicyanopentane, 2,6-dicyanoheptane, 2,7-dicyanooctane, 2,8-dicyanononane, 1,6-dicyanodecane, tetramethylsuccinonitrile, 2-methylglutaronitrile, 2,4-dimethylglutaronitrile, 3,5-dioxa-heptanedinitrile, 1,4-bis(cyanoethoxy) butane, ethylene glycol bis(2-cyanoethyl) ether, tricyanobenzene, acrylonitrile, crotononitrile, fumaronitrile, glycerol tricarbonitrile, and trans-hexenedinitrile.

In the present disclosure, the positive electrode active coating layer may further comprise a lithium-supplementing agent.

The addition of a lithium-supplementing agent in the positive electrode active coating layer can effectively compensate for the irreversible capacity loss of a battery with a high silicon content (for example, the mass content of the element Si in the negative electrode active coating layer is ≥5%) during the first charge-discharge process. Meanwhile, the remaining lithium ions can also persistently stabilize the surface structure of lithium cobalt oxide during the subsequent charge-discharge cycling of the battery, further mitigating the lattice structure collapse of lithium cobalt oxide caused by lithium-ion deintercalation, thereby improving the energy density of the battery and ensuring the charging performance of the battery throughout the entire service life.

In the present disclosure, the lithium-supplementing agent includes a material with a chemical formula of Li₅₊ₓFe_{y}M¹_{z}O₄ and/or a material with a chemical formula of Li_{2±a}Ni_{b}M_{c}O₂, where −0.5≤x≤5 (e.g., −0.5, 0, 1, 2, 3, 4, or 5), 0.8≤y≤1.2 (e.g., 0.8, 0.9, 1, 1.1, or 1.2), 0≤z≤1 (e.g., 0, 0.1, 0.2, 0.3, 0.4, 0.5, 0.6, 0.7, 0.8, 0.9 or 1), and M¹ comprises at least one of Mo, Nb, Ti, Zr, Ni, Y, Mn, Cu, Mg and Zn; and 0≤a≤0.5 (e.g., 0, 0.1, 0.2, 0.3, 0.4, or 0.5), 0≤b≤1 (e.g., 0, 0.1, 0.2, 0.3, 0.4, 0.5, 0.6, 0.7, 0.8, 0.9, or 1), 0≤c≤1 (e.g., 0, 0.1, 0.2, 0.3, 0.4, 0.5, 0.6, 0.7, 0.8, 0.9 or 1), and M² comprises at least one of Mo, Nb, Ti, Zr, Fe, Y, Mn, Cu, Mg and Zn.

In an embodiment, the lithium-supplementing agent includes Li₂NiO₂ and/or Li₅FeO₄.

In the present disclosure, the mass content c4 of the element M¹ and/or the element M² in the positive electrode active coating layer may be 900-7000 ppm, e.g., 900 ppm, 1000 ppm, 1500 ppm, 2000 ppm, 2500 ppm, 3000 ppm, 3500 ppm, 4000 ppm, 4500 ppm, 5000 ppm, 5500 ppm, 6000 ppm, 6500 ppm or 7000 ppm.

In an embodiment, c4 is 1600-6000 ppm.

The lithium-supplementing agent has poor conductivity and environmental adaptability and is prone to side reactions with moisture and carbon dioxide in the air, affecting the stability of the positive electrode plate; therefore, it is necessary to control the content of the lithium-supplementing agent in the positive electrode active coating layer. The value of c4 can reflect the content of the lithium-supplementing agent in the positive electrode active coating layer. When c4 falls within a specific range, the lithium-supplementing agent can compensate for the initial Coulombic efficiency (hereinafter abbreviated as the initial efficiency) and continuously replenish lithium ions during the cycling process of the battery, so as to further enhance the stability of the lattice structure of lithium cobalt oxide, without causing many side reactions to affect the stability of the positive electrode plate. If c4 is small (e.g., lower than 900 ppm), the content of the lithium-supplementing agent is too low to enhance the lattice structure of lithium cobalt oxide. A large c4 value (e.g., greater than 7000 ppm) indicates a higher content of the lithium-supplementing agent. This not only fails to ensure its own stability but also severely affects the shelf life of the lithium-supplementing agent in the actual production process, deteriorating the structural stability of the positive electrode plate. It will also lead to a deterioration in the fast-charging performance of the battery.

In the present disclosure, the mass content c4 of the element M¹ and/or the element M² in the positive electrode active coating layer can be determined by testing with a conventional method in the art, e.g., by ICP-OES. The specific test method is as follows: a battery is discharged to 0% SOC and then disassembled to take out a positive electrode plate, and the positive electrode plate is soaked in the solvent DMC for 12 h; and the positive electrode plate is then rinsed with the solvent DMC to remove a lithium salt adhered thereto and calcined in a muffle furnace at 400° C. for 3 h, the positive electrode active coating layer is then gently scraped off the surface of the positive electrode current collector, and the mass content (in ppm) of the element M¹ and/or the element M² is measured by ICP-OES. The specific operation method is carried out according to GB/T 30902-2014.

In the present disclosure, c4 and the mass content c2 of the element Si in the negative Electrode Active Coating Layer Satisfy: 0.005≤c4/c2≤0.19, e.g., 0.005, 0.006, 0.007, 0.008, 0.009, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18 or 0.19.

In an embodiment, 0.028≤c4/c2≤0.093.

The initial efficiency of the battery decreases as the mass content of the element Si in the negative electrode active coating layer increases, thus requiring a greater amount of the lithium-supplementing agent to compensate for the adverse effects of silicon on the initial efficiency of the battery. When the two do not satisfy the relationship above, an excess of the lithium-supplementing agent relative to the silicon-carbon material may occur, in which case the excess lithium-supplementing agent will lead to deterioration in both the fast-charging performance and stability of the battery. Alternatively, there may be a situation where the silicon-carbon material is in excess relative to the lithium-supplementing agent. In this case, an insufficient amount of the lithium-supplementing agent cannot effectively compensate for the initial efficiency, nor can it further enhance the lattice stability of lithium cobalt oxide through continuous lithium supplementation, which is likewise detrimental to the improvement of battery stability. Therefore, the relationship between the two needs to be adjusted and controlled. When a specific relationship is satisfied, the battery can achieve high initial efficiency and cycling stability while guaranteeing the fast-charging performance thereof.

In the present disclosure, the OI value of the negative electrode active coating layer may be 10-30, e.g., 10, 11, 12, 13, 14, 15, 16, 17, 18, 19, 20, 21, 22, 23, 24, 25, 26, 27, 28, 29, or 30.

In an embodiment, the OI value of the negative electrode active coating layer is 12-17.

In the present disclosure, the OI value of the negative electrode active coating layer can be determined by testing with a conventional method in the art. For example, a battery is discharged to 0% SOC and then disassembled to take out the negative electrode plate; the negative electrode plate is soaked in the solvent DMC for 12 h, and then rinsed with the solvent DMC to remove a lithium salt adhered thereto; and the negative electrode active coating layer is tested using an X-ray powder diffraction instrument (e.g. Shimadzu XRD-6100), and a diffraction pattern was obtained. With the intensity of the (004) peak at 2θ of 54°-55° being denoted as I₀₀₄, and the intensity of the (110) peak at 2θ of 77°-78° being denoted as I₁₁₀, the OI value is I₀₀₄/I₁₁₀.

The OI value of the negative electrode active coating layer can affect the expansion rate of the negative electrode plate in the thickness direction to some extent. Specifically, the OI value of the negative electrode active coating layer represents the overall orientation of the negative electrode active material. A smaller OI value indicates a lower expansion rate of the negative electrode active material in the thickness direction of the battery. The cycling stability of the battery can be further enhanced by adjusting and controlling the OI value of the negative electrode active coating layer.

In the present disclosure, the sphericity s of the primary spherical particles may be 0.7-1, for example 0.7, 0.8, 0.9 or 1.

In an embodiment, the sphericity s of the primary spherical particles is 0.8-0.95.

In the present disclosure, the sphericity s of the primary spherical particles can be determined by testing with a conventional method in the art. For example, a battery is discharged to 0% SOC and then disassembled to take out a negative electrode plate; the negative electrode plate is soaked in the solvent DMC for 12 h and then rinsed with the solvent DMC to remove a lithium salt adhered thereto; and the negative electrode active coating layer is then rinsed off the negative electrode current collector with deionized water, followed by ultrasonic treatment, centrifugation to remove the filtrate, and air drying, and the resulting powder is observed with SEM (under a high voltage mode). The image of the primary spherical particles of the silicon-carbon material in an SEM micrograph at a specific magnification (e.g. 2500×) is analyzed using an image processing software (e.g., Image Pro Plus). At least 10 primary spherical particles of the silicon-carbon material in the micrograph are selected to obtain the perimeter and area of each particle. The perimeter-equivalent radius and area-equivalent radius are calculated, respectively, then the sphericity=the area-equivalent radius/the perimeter-equivalent radius, and the average value is taken.

In the present disclosure, an outer surface of the negative electrode active coating layer can have first recesses. The negative electrode plate comprises a negative electrode current collector and the negative electrode active coating layer on a surface on at least one side of the negative electrode current collector. The outer surface of the negative electrode active coating layer refers to the surface of the negative electrode active coating layer facing away from the negative electrode current collector.

In the present disclosure, the spacing g between the first recesses and the sphericity s of the primary spherical particles satisfy: 0.4≤g×s≤2, where the spacing g between the first recesses is, in mm, for example, 0.4, 0.5, 0.6, 0.7, 0.8, 0.9, 1, 1.1, 1.2, 1.3, 1.4, 1.5, 1.6, 1.7, 1.8, 1.9 or 2.

In an embodiment, 0.6≤g×s≤1.5.

The first recesses on the surface of the negative electrode active coating layer can provide a certain release space for the volume expansion of the negative electrode active material and reduce the extension of the negative electrode current collector caused by the volume expansion of the negative electrode active material, thereby facilitating further improvement of the cycling stability of the battery. When the spacing between the first recesses is small, the first recesses on the surface of the negative electrode active coating layer are dense, exposing a larger area of the silicon-carbon material. In contrast, when the spacing between the first recesses is large, a smaller area of the silicon-carbon material is exposed. Generally, a lower sphericity of the silicon-carbon material indicates that the silicon-carbon material has more surface defects, which may have numerous protrusions and depressions. Moreover, silicon-carbon materials have a high hardness; thus, when their sphericity is lower, the protrusions and depressions on the surface may pierce the separator and cause a short circuit, or squeeze the positive electrode plate, increasing the risk of the positive electrode plate breaking. As the sphericity of the silicon-carbon material increases, its surface morphology becomes less sharp. In this case, the spacing between the first recesses can be appropriately reduced (a larger area of silicon-carbon material can be appropriately exposed). Therefore, by adjusting and controlling the relationship between the two, the kinetics on the negative electrode side can be enhanced while ensuring battery safety, thereby improving the fast-charging performance of the battery.

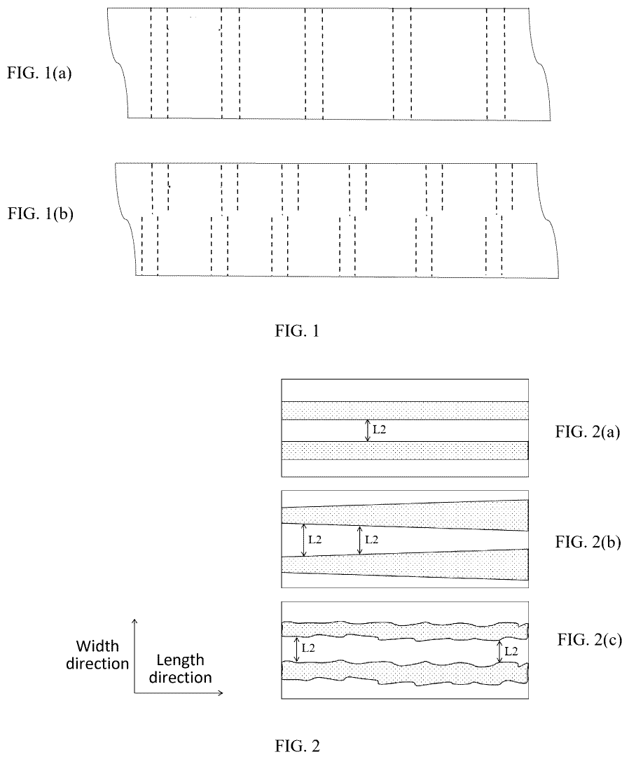

In the present disclosure, the first recesses can comprise either recessed holes or grooves. The first recesses can be achieved by laser drilling or scribing technology. The grooves can be arranged continuously or in segments. FIG. 1 shows a schematic view (top view) of grooves on a surface of a negative electrode plate in an example of the present disclosure, where in FIG. 1(a), the grooves are arranged continuously; and in FIG. 1(b), the grooves are arranged in segments. As can be seen from the figure, the surface of the negative electrode plate (i.e., the outer surface of the negative electrode active coating layer) has a plurality of grooves. In FIG. 1(a), the grooves are arranged continuously in the width direction of the negative electrode plate, and in FIG. 1(b), the grooves are arranged in segments in the width direction of the negative electrode plate. It will be appreciated that FIG. 1 only shows the case where the grooves are arranged in the width direction of the negative electrode plate; however, the grooves can also be arranged in the length direction of the negative electrode plate.

In the present disclosure, the spacing g between the first recesses may be 0.5-5 mm, e.g., 0.5 mm, 0.6 mm, 0.7 mm, 0.8 mm, 0.9 mm, 1 mm, 1.5 mm, 2 mm, 2.5 mm, 3 mm, 3.5 mm, 4 mm, 4.5 mm, or 5 mm.

In an embodiment, the spacing g between the first recesses is 0.8-1.5 mm.

When the first recesses are recessed holes, the spacing between the first recesses refers to the spacing between the recessed holes. The spacing between the recessed holes has the conventional meaning in the art. It refers to the shortest distance between the edges of two adjacent recessed holes on the surface of the negative electrode plate, and the spacing between the recessed holes can be determined by testing with a conventional means in the art. For example, by a 3D profile meter, all or at least 10 groups of adjacent recessed holes are selected, the spacing is measured, and the average value is taken.

When the first recesses are grooves, the spacing between the first recesses refers to the spacing between the grooves. It can be understood that when there is only one groove on the surface of the negative electrode plate, no groove spacing exists. The spacing between the grooves has the conventional meaning in the art. The orthographic projection of the grooves on the surface of the negative electrode plate includes two long sides. The spacing between the grooves refers to the average distance between two adjacent long sides of two adjacent grooves in the length direction or width direction of the negative electrode plate. FIG. 2 shows a schematic view of the spacing of grooves in an example of the present disclosure, where FIG. 2(a) shows the case where two adjacent long sides are straight and parallel, FIG. 2(b) shows the case where two adjacent long sides are straight and non-parallel, and FIG. 2(c) shows the case where two adjacent long sides are curved. In FIG. 2(a), two adjacent long sides are straight lines and arranged in parallel, and therefore, in the width direction, the distance from any point on one long side to the other long side is identical. In this case, the spacing between the grooves is the distance L2 from any point on one long side to the other long side in the width direction. In FIG. 2(b), two adjacent long sides are straight lines, but are not arranged in parallel. Therefore, in the width direction, the distance from any point on one long side to the other long side is not identical. In this case, the spacing between the grooves can be an average value. That is to say, on a long side, based on the length of the side, 50 points are selected at equal distance (that is, the inter-point distance is identical, and selecting points in this way can make the calculation result more accurate), the width L2 corresponding to each point is measured, and the average value is taken to obtain the spacing. In FIG. 2(c), two adjacent long sides are curves. Therefore, in the width direction, the distance from any point on one long side to the other long side is not identical. In this case, the spacing between the grooves can also be an average value. That is to say, 50 points are randomly selected on one long side (since the two long sides in FIG. 2(c) are curves, the relationship between the two long sides in FIG. 2(b) does not exist, and therefore, 50 points can be randomly selected for measurement), the width L2 corresponding to each point is measured, and the average value is taken to obtain the spacing. The spacing between the grooves can be determined by testing with a conventional means in the art. For example, the spacings between all the grooves or at least 5 grooves on the surface of the negative electrode active coating layer are measured by testing with a 3D profile meter, and the average value is taken.

In the present disclosure, the depth of the first recesses can be 5-40 μm, e.g., 5 μm, 10 μm, 15 μm, 20 μm, 25 μm, 30 μm, 35 μm, or 40 μm.

In one example, the depth of the first recesses is 15-30 μm.

The depth of the first recesses has the conventional meaning in the art and refers to the perpendicular distance from the lowest point in the first recesses to the surface of the negative electrode plate. The depth of the first recesses can be measured by testing with a conventional method in the art. For example, using a 3D profile meter, the depths of all the first recesses or at least 20 first recesses on the surface of the negative electrode active coating layer are measured, and the average value is taken.

In the present disclosure, the width of the first recesses can be 40-200 μm, e.g., 40 μm, 50 μm, 60 μm, 70 μm, 80 μm, 90 μm, 100 μm, 150 μm, or 200 μm.

In one example, the width of the first recesses is 60-100 μm.

When the first recesses are recessed holes, the width of the first recesses refers to the hole diameter of the recessed holes. The hole diameter of the recessed holes has the conventional meaning in the art. When the shape of the orthographic projection of the recessed holes on the surface of the negative electrode plate is a “regular circle”, the hole diameter of the recessed holes is the diameter of the regular circle; and when the shape of the orthographic projection of the recessed holes on the surface of the negative electrode plate is an “irregular circle” (e.g., an ellipse or an irregular curve polygon), the hole diameter of the recessed holes is the diameter of an equivalent circle with an area equal to that of the “irregular circle”. The hole diameter of the recessed holes can be determined by testing with a conventional means in the art. For example, the hole diameters of all the recessed holes or at least 20 recessed holes on the surface of the negative electrode active coating layer are measured with a 3D profile meter, and the average value is taken.

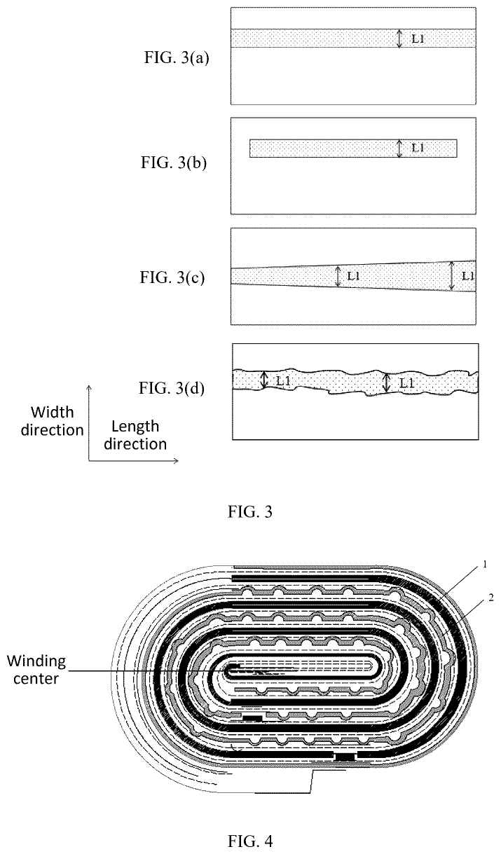

When the first recesses are grooves, the width of the first recesses refers to the width of the grooves. The width of the grooves has the conventional meaning in the art. The width of the grooves refers to the average distance from one long side to the other long side in the length direction or width direction of the negative electrode plate. FIG. 3 shows a schematic view of the width of grooves in an example of the present disclosure, where in FIGS. 3(a)-3(c), two long sides of the groove are straight lines, and in FIG. 3(d), two long sides of the groove are curved lines. In FIGS. 3(a) and 3(b), the two long sides are arranged in parallel, and therefore, in the width direction of the negative electrode plate, the perpendicular distance from any point on one long side to the other long side is identical. In this case, the width of the grooves is the perpendicular distance L1 from any point on one long side to the other long side in the length direction or width direction of the negative electrode plate. In FIG. 3(c), the two long sides of a groove are straight lines, but are not arranged in parallel. Therefore, in the width direction, the distance from any point on one long side to the other long side is not identical. In this case, the width of the groove can be an average value. That is to say, on a long side, based on the length of the side, 50 points are selected at equal distance (that is, the inter-point distance is identical, and selecting points in this way can make the calculation result more accurate), the width L1 corresponding to each point is measured, and the average value is taken to obtain the width of the groove. In FIG. 3(d), the two long sides are curves. Therefore, in the width direction, the size from any point on one long side to the other long side is not identical. In this case, the width of the groove can also be an average value. That is to say, 50 points are randomly selected on one long side (since the two long sides in FIG. 3(d) are curves, the relationship between the two long sides in FIG. 3(c) does not exist, and therefore, 50 points can be randomly selected for measurement), the width L1 corresponding to each point is measured, and the average value is taken to obtain the width of the groove. The width of the grooves can be determined by testing with a conventional means in the art. For example, the widths of all the grooves or at least 5 grooves on the surface of the negative electrode active coating layer are measured by testing with a 3D profile meter, and the average value is taken.

In the present disclosure, the silicon-carbon material further comprises secondary spherical particles formed from a plurality of the primary spherical particles. The term “plurality of” means that the number of the primary spherical particles forming the secondary spherical particles is greater than or equal to 2.

Conventionally used silicon-carbon materials are blocky, with an average particle size of about 6-12 μm. Therefore, they have poor conductivity and are difficult to achieve a large compaction density, with limited improvement in energy density. Thus, they are not suitable for 5% silicon-doped (i.e., the mass content of the element Si in the negative electrode active coating layer is 5%) battery system. In the present disclosure, a silicon-carbon material including primary spherical particles is used as the negative electrode active material. Primary spherical particles with a relatively small particle size are beneficial to improve the energy density of the battery; However, due to the relatively small particle size thereof, the specific surface area is relatively large, so that the risk of side reactions with the electrolyte is correspondingly increased, leading to a relatively poor stability. In order to reduce the side reactions between the silicon-carbon material and the electrolyte, the secondary spherical particles formed from a plurality of the primary spherical particles are further added. The secondary spherical particles with a relatively large particle size have a relatively small specific surface area, so the risk of side reactions with the electrolyte is relatively low, leading to a relatively good stability.

In the present disclosure, the average particle size of the secondary spherical particles can be 3-20μ, e.g., 3 μm, 4 μm, 5μ, 6 μm, 7 μm, 8 μm, 9 μm, 10 μm, 11μ, 12 μm, 13 μm, 14 μm, 15 μm, 16 μm, 17 μm, 18 μm, 19 μm, or 20 μm.

In the present disclosure, the average particle size of the secondary spherical particles can be determined by testing with a conventional method in the art. For example, a battery is discharged to 0% SOC and then disassembled to take out a negative electrode plate; the negative electrode plate is soaked in the solvent DMC for 12 h and then rinsed with the solvent DMC to remove a lithium salt adhered thereto and cut by argon ion grinder CP laser and then observed by SEM (under a high-voltage mode); and after measurement at a magnification of 5K, at least 20 secondary spherical particles are randomly selected to measure the particle size of each secondary spherical particle, and the average value is taken. If the number of secondary spherical particles is less than 20 at the magnification of 5K, another microscope image is taken until the 20 secondary spherical particles are measured.

In the present disclosure, the proportion of the number of the primary spherical particles in the negative electrode active coating layer relative to the total number of the primary spherical particles and the secondary spherical particles is 0.1-0.9, e.g., 0.1, 0.2, 0.3, 0.4, 0.5, 0.6, 0.7, 0.8, or 0.9.

In one example, the proportion of the number of the primary spherical particles in the negative electrode active coating layer relative to the total number of the primary spherical particles and the secondary spherical particles is 0.3-0.8.

In the present disclosure, the number of the primary spherical particles and the number of the secondary spherical particles in the negative electrode active coating layer can be determined by testing with a conventional method in the art. For example, a battery is discharged to 0% SOC and then disassembled to take out a negative electrode plate, the negative electrode plate is soaked in the solvent DMC for 12 h and then rinsed with the solvent DMC to remove a lithium salt adhered thereto and cut along the thickness direction of the negative electrode plate by argon ion grinder CP laser and then observed by SEM (using a high-voltage mode) to obtain a microscope image of the cross section of the negative electrode plate along the thickness direction; after observation at a magnification of 1K, at least 20 microscope images of different cross sections are selected, the number of the primary spherical particles and the number of the secondary spherical particles in each microscope image are counted separately, and the average value is taken.

In the present disclosure, the negative electrode active material can further comprise a graphite material. The graphite material includes, for example, artificial graphite and/or natural graphite. The graphite material comprises secondary particles. The secondary particles are formed from a plurality of primary particles. The term “plurality of” means that the number of the primary particles forming the secondary particles is greater than or equal to 2.

In the present disclosure, the average particle size of the secondary particles can be 6-20 μm, e.g., 6μ, 7μ, 8μ, 9μ, 10μ, 11μ, 12 μm, 13 μm, 14 μm, 15 μm, 16 μm, 17 μm, 18 μm, 19 μm, or 20 μm.

By using a specific graphite material in combination and adjusting and controlling the structure and particle size of the graphite material, the graphite material comprises secondary particles formed from primary particles, and the average particle size of the secondary particle is 6-20 μm, so that the energy density of the battery can be further improved. Compared with a graphite material of primary particles, secondary particles of the graphite material with a specific particle size can improve the energy density of the battery. Therefore, the graphite material has a relatively high matching degree with the specific silicon-carbon material, which is beneficial to the improvement of the energy density of the battery.

In the present disclosure, the average particle size of the secondary particles can be determined by testing with a conventional method in the art. For example, a battery is discharged to 0% SOC and then disassembled to take out a negative electrode plate; the negative electrode plate is soaked in the solvent DMC for 12 h and then rinsed with the solvent DMC to remove a lithium salt adhered thereto, and the negative electrode active coating layer is then rinsed off a negative electrode current collector with deionized water, followed by an ultrasonic treatment, centrifugation to remove the filtrate, and air drying; and the obtained sample is dispersed in deionized water containing nonylphenol polyoxyethylene ether (in which the mass content of nonylphenol polyoxyethylene ether is 0.02-0.03%) to form a mixture, and after an ultrasonic treatment for 2 minutes, the sample is tested by Malvern particle size tester to obtain median particle size Dv50 data, namely the average particle size of secondary particles. Due to the specific composition and particle size of the graphite material and silicon-carbon material in the present disclosure, the silicon-carbon material has little influence on the average particle size of the secondary particles of the graphite material, and therefore, the data obtained by using the above test method is namely the average particle size of the secondary particles.

In the present disclosure, the positive electrode plate can comprise a positive electrode current collector and the positive electrode active coating layer on a surface on at least one side of the positive electrode current collector. The length of the positive electrode active coating layer on a first surface of the positive electrode current collector is greater than the length of the positive electrode active coating layer on a second surface of the positive electrode current collector. It can be appreciated that when coating the positive electrode plate, there are a single-sided coated region and a double-sided coated region, wherein the single-sided coated region is namely a positive electrode current collector in the region, and only the surface on one side has the positive electrode active coating layer; and the double-sided coated region is namely the positive electrode current collector in the region, and the surfaces on both sides have the positive electrode active coating layer. This leads to the case where the lengths of the positive electrode active coating layers on the surfaces on both sides of the positive electrode plate are not identical. In the present disclosure, the surface of the positive electrode active coating layer on the relatively long length surface of the positive electrode current collector is defined as a first surface, and the relatively short length surface of the positive electrode active coating layer is defined as a second surface. A region where a projection of the positive electrode active coating layer on the first surface overlaps with a projection of the positive electrode active coating layer on the second surface in the thickness direction of the positive electrode plate is namely the double-sided coated region, and a region where the projections do not overlap is namely single-sided coated region. Due to the special structure of a wound battery, the first surface usually faces the winding center of the jelly roll, and the second surface faces away from the winding center of the jelly roll.

In the present disclosure, a surface of the positive electrode active coating layer on the first surface has second recesses, and a surface of the positive electrode active coating layer on the second surface has protrusions. Embossing the surface of the positive electrode plate can obtain a structure with recesses on one side and protrusions on the other side.

The storage location of the electrolyte in the battery is distributed in the gap between the jelly roll and an aluminum-plastic film and the interlayer gap in the electrode plates. Interlayer storage mainly depends on slow infiltration by pores in the electrode plates and capillary effects, which requires a longer time and is more difficult in infiltration than the case of the gap between the jelly roll and the aluminum-plastic film. Therefore, the liquid storage capacity of the inner layers of electrode plate of the jelly roll is significantly less than that of the outer layers of electrode plate. By performing an embossing process on the positive electrode plate so that one side has recesses and the other side has protrusions, more liquid storage places can be provided, the ion transport distance is shortened, and the polarization of the positive and negative electrode plates is reduced, thus improving the overall charging speed of the battery.

Furthermore, the inventors of the present disclosure have conducted stress analysis on the positive electrode active coating layer facing and away from the winding center in the jelly roll and have found that when the first surface facing the winding center is provided with second recesses and the second surface away from the winding center is provided with protrusions, this is not only beneficial to the structural stability of the positive electrode plate itself, but can also provide a better buffer space for the volume expansion of the negative electrode plate, so that the cycling life of the battery can be prolonged. FIG. 4 shows a schematic view of the structure of a jelly roll in an example of the present disclosure. As can be seen from the figure, the jelly roll comprises a negative electrode plate 1 and a positive electrode plate 2; the surface of the positive electrode active coating layer on the first surface has second recesses, and the surface of the positive electrode active coating layer on the second surface has protrusions; and the first surface faces the winding center of the jelly roll, and the second surface faces away from the winding center of the jelly roll.

In the present disclosure, the shapes of the orthographic projections of the second recesses and the protrusions on the surface of the positive electrode plate are not limited and can be circular, elliptical, linear (including straight or wavy lines), polygonal, or other shapes.

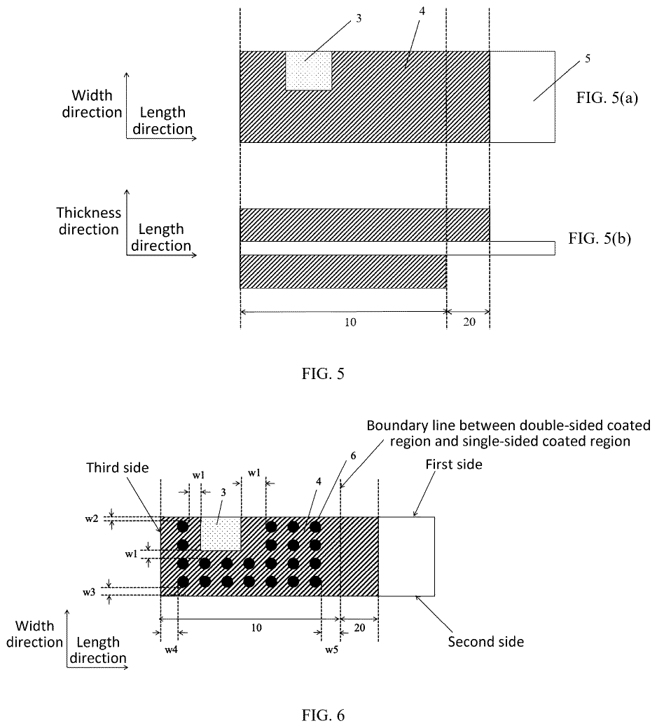

In the present disclosure, the positive electrode plate comprises a positive electrode tab welding region, a pasted region, and an uncoated foil region. The uncoated foil region refers to the region on the positive electrode current collector that is not coated with the positive electrode active coating layer except the positive electrode tab welding region. The pasted region comprises the double-sided coated region and the single-sided coated region. FIG. 5 shows a schematic view of the structure of a positive electrode plate in an example of the present disclosure, wherein FIG. 5(a) is a top view, and FIG. 5(b) is a cross-sectional view along the thickness direction. As can be seen from the figure, the positive electrode plate comprises a positive electrode tab welding region 3, a pasted region 4, and uncoated foil region 5, wherein the pasted region 4 comprises a double-sided coated region 10 and a single-sided coated region 20.

In one example, the second recesses and the protrusions are provided on the pasted region.

In one example, the second recesses and the protrusions are provided in the double-sided coated region.

In one example, the second recesses and the protrusions are provided on the pasted region and provided on the double-sided coated region.

In the present disclosure, the distance from the second recesses to an edge of the positive electrode tab welding region is w1, with 0 mm<w1≤10 mm, e.g., 0.1 mm, 0.5 mm, 1 mm, 2 mm, 3 mm, 4 mm, 5 mm, 6 mm, 7 mm, 8 mm, 9 mm, or 10 mm.

In the present disclosure, the distance from the second recesses to an edge of a first side of the pasted region is w2, with 2 mm≤w2≤40 mm, e.g., 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 25 mm, 30 mm, 35 mm, or 40 mm. The first side is the side where the positive electrode tab welding region is provided.

In the present disclosure, the distance from the second recesses to an edge of a second side of the pasted region is w3, with 2 mm≤w3≤25 mm, e.g., 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, or 25 mm. The second side is a side opposite to the side where the positive electrode tab welding region is provided.

In the present disclosure, the distance from the second recesses to an edge of a third side of the pasted region is w4, with 0 mm<w4≤20 mm, e.g., 0.1 mm, 0.5 mm, 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, or 20 mm. The third side is a side of the pasted region close to a winding head end.

In the present disclosure, the distance from the second recesses to a boundary line between the double-sided coated region and the single-sided coated region is w5, with 0 mm<w5≤20 mm, e.g., 0.1 mm, 0.5 mm, 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, or 20 mm.

By controlling w1, w2, w3, w4, and w5, it can ensure that the positive electrode plate does not shed powder, which is beneficial to improving the cycling life of the battery.

FIG. 6 shows a schematic top view of a first surface of a positive electrode plate in an example of the present disclosure. As can be seen from the figure, the first surface has a plurality of second recesses 6, wherein the distance from the second recesses 6 to an edge of the positive electrode tab welding region 3 is w1, the distance from the second recesses 6 to the edge of the first side of the pasted region 4 is w2, the distance from the second recesses 6 to the edge of the second side of the pasted region 4 is w3, the distance from the second recesses 6 to the edge of the third side of the pasted region 4 is w4, and the distance from the second recesses 6 to the boundary line between the double-sided coated region 10 and the single-sided coated region 20 is w5.

In the present disclosure, the depth of the second recesses can be 3-40 μm, e.g., 3 μm, 5 μm, 10μ, 15 μm, 20 μm, 25 μm, 30 μm, 35 μm, or 40 μm. The height of the protrusions can be 3-40 μm, e.g., 3 μm, 5 μm, 10 μm, 15 μm, 20 μm, 25 μm, 30 μm, 35 μm, or 40 μm.

In the present disclosure, the depth of the second recesses and the height of the protrusions have the conventional meanings in the art. The depth of the second recesses refers to the perpendicular distance from the lowest point in the second recesses to the surface of the positive electrode plate. The height of the protrusions refers to the perpendicular distance from the highest point on the protrusions to the surface of the positive electrode plate. The depth of the second recesses and the height of the protrusions can be determined by testing with a conventional method in the art. For example, by a 3D profile meter, at least 20 second recesses or 20 protrusions are selected on the surface of the positive electrode plate, the depth of each second recess is measured, and an average value is taken to obtain the depth of the second recesses; and the height of each protrusion is measured, and an average value is taken to obtain the height of the protrusions.

In the present disclosure, the width of the second recesses can be 0.2-8 mm, e.g., 0.2 mm, 0.5 mm, 1 mm, 2 mm, 3 mm, 4 mm, 5 mm, 6 mm, 7 mm, or 8 mm. The width of the protrusions can be 0.2-8 mm, e.g., 0.2 mm, 0.5 mm, 1 mm, 2 mm, 3 mm, 4 mm, 5 mm, 6 mm, 7 mm, or 8 mm.

In one example, the width of the second recesses is 1-3 mm. The width of the protrusions is 1-3 mm.

In the present disclosure, when the shape of the projection of the second recesses in the thickness direction of the positive electrode plate is a regular circle, the width of the second recesses is namely the diameter of the regular circle; When the shape of the projection of the second recesses in the thickness direction of the positive electrode plate is an “irregular circle”, the width of the second recesses is namely the equivalent diameter of a circle with the same area as the irregular circle. By the same reasoning, when the shape of the projection of the protrusions in the thickness direction of the positive electrode plate is a regular circle, the width of the protrusions is namely the diameter of the regular circle; and when the shape of the projection of the protrusions in the thickness direction of the positive electrode plate is an “irregular circle”, the width of the protrusions is namely the equivalent diameter of a circle with the same area as the irregular circle. The width of the second recesses and the width of the protrusions can be determined by testing with a conventional method in the art. For example, by a 3D profile meter, at least 10 second recesses and 10 protrusions are selected on the surface of the positive electrode plate, the width of each second recess and the height of the protrusion are measured, and average values are taken.

In the present disclosure, the spacing between the second recesses can be 0.5-8 mm, e.g., 0.5 mm, 1 mm, 2 mm, 3 mm, 4 mm, 5 mm, 6 mm, 7 mm, or 8 mm. The spacing between the protrusions can be 0.5-8 mm, e.g., 0.5 mm, 1 mm, 2 mm, 3 mm, 4 mm, 5 mm, 6 mm, 7 mm, or 8 mm.

In one example, the spacing between the second recesses is 1-3 mm. The spacing between the protrusions is 1-3 mm.

In the present disclosure, the spacing between the second recesses refers to the shortest distance between the edges of the orthographic projections of two adjacent second recesses on the surface of the positive electrode plate. By the same reasoning, the spacing between the protrusions refers to the shortest distance between the edges of the orthographic projections of two adjacent protrusions on the surface of the positive electrode plate. The spacing between the second recesses and the spacing between the protrusions can be determined by testing with a conventional method in the art. For example, by a 3D profile meter, at least 10 groups of adjacent second recesses or protrusions are selected on the surface of the positive electrode plate, the spacing is measured, and the average value is taken.

In the present disclosure, the positive electrode active coating layer can further comprise a positive electrode conductive agent and a positive electrode binder, and the negative electrode active coating layer can further comprise a negative electrode conductive agent and a negative electrode binder. For both the positive electrode conductive agent and the negative electrode conductive agent, conductive agents conventionally used in the art can be used. For both the positive electrode binder and the negative electrode binder, binders conventionally used in the art can be used.

In the present disclosure, the lithium-ion secondary battery can further comprise a separator, which may be a conventional choice in the art.

It should be noted that the digital representations such as “first” and “second” in the present disclosure are only used to distinguish different materials or usage modes and do not represent the difference in order.

The present disclosure will be described in detail below by means of examples. The examples described in the present disclosure are only some, rather than all, of the examples of the present disclosure. Based on the examples in the present disclosure, all other examples obtained by those of ordinary skill in the art without involving creative effort belong to the scope of protection of the present disclosure.

In the following examples, unless otherwise specified, all the materials used are commercially available and analytically pure.

The following examples are used to illustrate the lithium-ion secondary battery of the present disclosure.

### Example 1

A battery was prepared according to the following method:

### (1) Preparation of Positive Electrode Plate

Lithium cobalt oxide (with M³ including Al), a lithium-supplementing agent (Li₂NiO₂), a positive electrode conductive agent (conductive carbon black), and a positive electrode binder (polyvinylidene fluoride) were mixed in a mass ratio of 95.563:0.437:1:2, then N-methylpyrrolidone (NMP) was added, and the mixture was stirred until uniform to prepare a positive electrode slurry; the above positive electrode slurry was applied to a first surface and a second surface of an aluminum foil (the coating length of the positive electrode slurry on the first surface of the aluminum foil was greater than that on the second surface), and the aluminum foil was baked and rolled to obtain a positive electrode plate with a thickness of 100 um; a positive electrode tab welding region with a fixed size (the size of the positive electrode tab welding region in the width direction of the positive electrode plate was 20 mm) was provided on the pasted region of the positive electrode plate, and a nickel tab was welded in the above positive electrode tab welding region by laser; furthermore, after passing over a roller, an embossing treatment was carried out from the first surface to the second surface in the double-sided coated region (with the positive electrode tab welding region being avoided) to obtain second recesses (first surface) and protrusions (second surface), wherein the shape of the orthographic projections of the second recesses and the protrusions on the surface of the positive electrode plate was circular;

wherein the mass content c1 of the element Al in the positive electrode active coating layer was 8965 ppm, c4 was 2563 ppm, and the second recesses had a width of 3 mm, a depth of 30 μm, and a spacing of 3 mm; and w1 was 7 mm, w2 was 27 mm, w3 was 15 mm, w4 was 7 mm, and w5 was 7 mm.

### (2) Preparation of Negative Electrode Plate

Artificial graphite (secondary particles), a silicon-carbon material (the proportion of the number of primary spherical particles relative to the total number of the primary spherical particles and secondary spherical particles was 0.56, the average particle size of the primary spherical particles was 4.1 μm, the sphericity s of the primary spherical particles was 0.87, and the mass content of the element Si in the silicon-carbon material was 50%), a negative electrode conductive agent (carbon nanotubes), a negative electrode dispersant (lithium carboxymethyl cellulose), and a negative electrode binder (polyacrylic acid) were mixed in a mass ratio of 85:12:0.4:0.1:2.5, and then deionized water was added to prepare a negative electrode slurry; the above negative electrode slurry was applied to the surfaces on both sides of a carbon-coated copper foil, baked, and rolled to obtain a negative electrode plate with a thickness of 110 μm; and first recesses (grooves) were made on the surface of the negative electrode plate by laser;
wherein the mass content c2 of the element Si in the negative electrode active coating layer was 6%, the OI value of the negative electrode active coating layer was 14.3, and the grooves had a width of 80.5 μm, a depth of 20.2 μm, and a spacing g of 1.2 mm; and g x s was 1.044 and c4/c2 was 0.0427.

### (3) Preparation of Electrolyte

In a glove box (H₂O<0.01 ppm, O₂<0.01 ppm, and Ar atmosphere), ethylene carbonate, propylene carbonate, and diethyl carbonate were mixed in a weight ratio of 1:3:6 to obtain an organic solvent; fluorovinyl carbonate, HTCN and a lithium salt of lithium hexafluorophosphate were dissolved in the above organic solvent to obtain an electrolyte, wherein the mass content c3 of HTCN in the electrolyte was 2.3%; and the mass content of fluorovinyl carbonate in the electrolyte was 23% and the mass content of lithium hexafluorophosphate in the electrolyte was 12.5%;
wherein c2/c3 was 2.6.

### (4) Preparation of Battery

The positive electrode plate prepared in step (1), a separator (comprising a polyethylene base film with a thickness of 4 μm, a ceramic layer with a thickness of 2 μm on a surface on one side of the base film, a polymethyl methacrylate adhesive layer with a thickness of 0.5 μm on a surface on the other side of the base film, and a polyvinylidene fluoride+polymethyl methacrylate adhesive layer with a thickness of 2.5 μm on the outer surface of the ceramic layer), and the negative electrode plate prepared in step (2) were wound to obtain a jelly roll; and after encapsulation, baking, injection, formation, secondary encapsulation, sorting, and OCV, the battery was obtained.

### Example 2

A battery was prepared according to the following method:

### (1) Preparation of Positive Electrode Plate

Lithium cobalt oxide (with M³ including Al), a lithium-supplementing agent (Li₂NiO₂), a positive electrode conductive agent (conductive carbon black), and a positive electrode binder (polyvinylidene fluoride) were mixed in a mass ratio of 96.71:0.29:1:2, then N-methylpyrrolidone (NMP) was added, and the mixture was stirred until uniform to prepare a positive electrode slurry; the above positive electrode slurry was applied to a first surface and a second surface of an aluminum foil (the coating length of the positive electrode slurry on the first surface of the aluminum foil was greater than that on the second surface), and the aluminum foil was baked and rolled to obtain a positive electrode plate with a thickness of 100 μm; a positive electrode tab welding region with a fixed size (the size of the positive electrode tab welding region in the width direction of the positive electrode plate was 15 mm) was provided on the pasted region of the positive electrode plate, and a nickel tab was welded in the above positive electrode tab welding region by laser; furthermore, after passing over a roller, an embossing treatment was carried out from the first surface to the second surface in the double-sided coated region (with the positive electrode tab welding region being avoided) to obtain second recesses (first surface) and protrusions (second surface), wherein the shape of the orthographic projections of the second recesses and the protrusions on the surface of the positive electrode plate was circular;
wherein the mass content c1 of the element Al in the positive electrode active coating layer was 6531 ppm, c4 was 1698 ppm, and the second recess had a width of 2 mm, a depth of 20 μm, and a spacing of 2 mm; and w1 was 5 mm, w2 was 20 mm, w3 was 10 mm, w4 was 5 mm, and w5 was 5 mm.

### (2) Preparation of Negative Electrode Plate

Artificial graphite (secondary particles), a silicon-carbon material (the proportion of the number of primary spherical particles relative to the total number of the primary spherical particles and secondary spherical particles was 0.32, the average particle size of the primary spherical particles was 3.1 μm, the sphericity s of the primary spherical particles was 0.81, and the mass content of the element Si in the silicon-carbon material was 50%), a negative electrode conductive agent (carbon nanotubes), a negative electrode dispersant (lithium carboxymethyl cellulose), and a negative electrode binder (polyacrylic acid) were mixed in a mass ratio of 85:12:0.4:0.1:2.5, and then deionized water was added to prepare a negative electrode slurry; the above negative electrode slurry was applied to the surfaces on both sides of a carbon-coated copper foil, baked, and rolled to obtain a negative electrode plate with a thickness of 110 μm; and first recesses (grooves) were made on the surface of the negative electrode plate by laser;
wherein the mass content c2 of the element Si in the negative electrode active coating layer was 6%, the OI value of the negative electrode active coating layer was 12.1, and the grooves had a width of 60.3 μm, a depth of 15.1 μm, and a spacing g of 0.8 mm; and g x s was 0.648 and c4/c2 was 0.0283.

### (3) Preparation of Electrolyte

In a glove box (H₂O<0.01 ppm, O₂<0.01 ppm, and Ar atmosphere), ethylene carbonate, propylene carbonate, and diethyl carbonate were mixed in a weight ratio of 1:3:6 to obtain an organic solvent; and fluorovinyl carbonate, HTCN and a lithium salt of lithium hexafluorophosphate were dissolved in the above organic solvent to obtain an electrolyte; wherein the mass content c3 of HTCN in the electrolyte was 1.5%; and the mass content of fluorovinyl carbonate in the electrolyte was 23% and the mass content of lithium hexafluorophosphate in the electrolyte was 12.5%;
wherein c2/c3 was 4.

### (4) Preparation of Battery

The positive electrode plate prepared in step (1), a separator (comprising a polyethylene base film with a thickness of 4 μm, a ceramic layer with a thickness of 2 μm on a surface on one side of the base film, a polymethyl methacrylate adhesive layer with a thickness of 0.5 μm on a surface on the other side of the base film, and a polyvinylidene fluoride+polymethyl methacrylate adhesive layer with a thickness of 2.5 μm on the outer surface of the ceramic layer), and the negative electrode plate prepared in step (2) were wound to obtain a jelly roll; and after encapsulation, baking, injection, formation, secondary encapsulation, sorting, and OCV, the battery was obtained.

### Example 3

A battery was prepared according to the following method:

### (1) Preparation of Positive Electrode Plate

Lithium cobalt oxide (with M³ including Al), a lithium-supplementing agent (Li₂NiO₂), a positive electrode conductive agent (conductive carbon black), and a positive electrode binder (polyvinylidene fluoride) were mixed in a mass ratio of 96.056:0.944:1:2, then N-methylpyrrolidone (NMP) was added, and the mixture was stirred until uniform to prepare a positive electrode slurry; the above positive electrode slurry was applied to a first surface and a second surface of an aluminum foil (the coating length of the positive electrode slurry on the first surface of the aluminum foil was greater than that on the second surface), and the aluminum foil was baked and rolled to obtain a positive electrode plate with a thickness of 100 μm; a positive electrode tab welding region with a fixed size (the size of the positive electrode tab welding region in the width direction of the positive electrode plate was 25 mm) was provided on the pasted region of the positive electrode plate, and a nickel tab was welded in the above positive electrode tab welding region by laser; furthermore, after passing over a roller, an embossing treatment was carried out from the first surface to the second surface in the double-sided coated region (with the positive electrode tab welding region being avoided) to obtain second recesses (first surface) and protrusions (second surface), wherein the shape of the orthographic projections of the second recesses and the protrusions on the surface of the positive electrode plate was circular;
wherein the mass content c1 of the element Al in the positive electrode active coating layer was 11962 ppm, c4 was 5562 ppm, and the second recess had a width of 1 mm, a depth of 10 μm, and a spacing of 1 mm; and w1 was 9 mm, w2 was 34 mm, w3 was 20 mm, w4 was 10 mm, and w5 was 10 mm.

### (2) Preparation of Negative Electrode Plate

Artificial graphite (secondary particles), a silicon-carbon material (the proportion of the number of primary spherical particles relative to the total number of the primary spherical particles and secondary spherical particles was 0.79, the average particle size of the primary spherical particles was 5 μm, the sphericity s of the primary spherical particles was 0.95, and the mass content of the element Si in the silicon-carbon material was 50%), a negative electrode conductive agent (carbon nanotubes), a negative electrode dispersant (lithium carboxymethyl cellulose), and a negative electrode binder (polyacrylic acid) were mixed in a mass ratio of 85:12:0.4:0.1:2.5, and then deionized water was added to prepare a negative electrode slurry; the above negative electrode slurry was applied to the surfaces on both sides of a carbon-coated copper foil, baked, and rolled to obtain a negative electrode plate with a thickness of 110 μm; and first recesses (grooves) were made on the surface of the negative electrode plate by laser;
wherein the mass content c2 of the element Si in the negative electrode active coating layer was 6%, the OI value of the negative electrode active coating layer was 16.9, and the grooves had a width of 99.6 μm, a depth of 30 μm, and a spacing g of 1.5 mm; and g x s was 1.425 and c4/c2 was 0.0927.

### (3) Preparation of Electrolyte

In a glove box (H₂O<0.01 ppm, O₂<0.01 ppm, and Ar atmosphere), ethylene carbonate, propylene carbonate, and diethyl carbonate were mixed in a weight ratio of 1:3:6 to obtain an organic solvent; and fluorovinyl carbonate, HTCN and a lithium salt of lithium hexafluorophosphate were dissolved in the above organic solvent to obtain an electrolyte; wherein the mass content c3 of HTCN in the electrolyte was 3%; and the mass content of fluorovinyl carbonate in the electrolyte was 23% and the mass content of lithium hexafluorophosphate in the electrolyte was 12.5%;
wherein c2/c3 was 2.

### (4) Preparation of Battery

The positive electrode plate prepared in step (1), a separator (comprising a polyethylene base film with a thickness of 4 μm, a ceramic layer with a thickness of 2 μm on a surface on one side of the base film, a polymethyl methacrylate adhesive layer with a thickness of 0.5 μm on a surface on the other side of the base film, and a polyvinylidene fluoride+polymethyl methacrylate adhesive layer with a thickness of 2.5 μm on the outer surface of the ceramic layer), and the negative electrode plate prepared in step (2) were wound to obtain a jelly roll; and after encapsulation, baking, injection, formation, secondary encapsulation, sorting, and OCV, the battery was obtained.

### Example 4 Group

This group of examples was used to verify the influence of the change of “the mass content c1 of the element Al in the positive electrode active coating layer”.

This group of examples was carried out with reference to Example 1, except that c1 was changed, specifically as follows:
in Example 4a, c1 was 6017 ppm; and
in Example 4b, c1 was 14982 ppm.

### Example 5 Group

This group of examples was used to verify the influence of the change of “the mass content c2 of the element Si in the negative electrode active coating layer”.

This group of examples was carried out with reference to Example 1, except that c2 was adjusted by changing the mass contents of the graphite material and the silicon-carbon material in the negative electrode slurry, specifically as follows:
in Example 5a, artificial graphite, a silicon-carbon material, a negative electrode conductive agent, a negative electrode dispersant, and a negative electrode binder were mixed in a mass ratio of 91:6:0.4:0.1:2.5; wherein c2 was 3%, c2/c3 was 1.3, and c4/c2 was 0.0854;
in Example 5b, artificial graphite, a silicon-carbon material, a negative electrode conductive agent, a negative electrode dispersant, and a negative electrode binder were mixed in a mass ratio of 75:22:0.4:0.1:2.5; wherein c2 was 11%, c2/c3 was 4.78, and c4/c2 was 0.0233;
in Example 5c, artificial graphite, a silicon-carbon material, a negative electrode conductive agent, a negative electrode dispersant, and a negative electrode binder were mixed in a mass ratio of 94:3:0.4:0.1:2.5; wherein c2 was 1.5%, c2/c3 was 0.65, and c4/c2 was 0.1709;
in Example 5d, artificial graphite, a silicon-carbon material, a negative electrode conductive agent, a negative electrode dispersant, and a negative electrode binder were mixed in a mass ratio of 65:32:0.4:0.1:2.5; wherein c2 was 16%, c2/c3 was 6.96, and c4/c2 was 0.016.

### Example 6 Group

This group of examples was used to verify the influence of the change of “the average particle size of the primary spherical particles”.

This group of examples was carried out with reference to Example 1, except that the average particle size of the primary spherical particles was changed, specifically as follows:
in Example 6a, the average particle size of the primary spherical particles was 1.3 μm; and
in Example 6b, the average particle size of the primary spherical particles was 6 μm.

### Example 7 Group

This group of examples was used to verify the influence of the change of “the ratio c2/c3 of the mass content c2 of the element Si in the negative electrode active coating layer to the mass content c3 of HTCN in the electrolyte”.

This group of examples was carried out with reference to Examples 5a and 5b, respectively, except that c2/c3 was adjusted and controlled by changing c3, specifically as follows:
Example 7a was carried out with reference to Example 5a, except that c3 was 3%, and c2/c3 was 1; and
Example 7b was carried out with reference to Example 5b, except that c3 was 1.5%, and c2/c3 was 7.33.
Example 8 group

This group of examples was used to verify the influence of the change of “the lithium-supplementing agent”.

This group of examples was carried out with reference to Example 1, except that no lithium-supplementing agent was added or the type of the lithium-supplementing agent was varied, specifically as follows:
in Example 8a, no lithium-supplementing agent was added to the positive electrode slurry, that is, lithium cobalt oxide, a positive electrode conductive agent and a positive electrode binder were mixed in a mass ratio of 97:1:2; and
in Example 8b, the lithium-supplementing agent was replaced with an equal mass of Li5FeO₄, and the mass content c4 of Fe in the positive electrode active coating layer was 3844 ppm.

### Example 9 Group

This group of examples was used to verify the influence of the change of “the mass content c4 of the element M¹ and/or element M² in the positive electrode active coating layer”.

This group of examples was carried out with reference to Example 1, except that c4 was adjusted and controlled by changing the mass content of the lithium-supplementing agent in the positive electrode slurry, specifically as follows:
in Example 9a, lithium cobalt oxide, a lithium-supplementing agent, a positive electrode conductive agent, and a positive electrode binder were mixed in a mass ratio of 96.844:0.156:1:2; wherein c4 was 912 ppm and c4/c2 was 0.0152; and
in Example 9b, lithium cobalt oxide, a lithium-supplementing agent, a positive electrode conductive agent, and a positive electrode binder were mixed in a mass ratio of 95.828:1.172:1:2; wherein c4 was 6923 ppm and c4/c2 was 0.1154.

### Example 10 Group

This group of examples was used to verify the influence of the change of “the ratio c4/c2 of the mass content c4 of the element M¹ and/or element M² in the positive electrode active coating layer to the mass content c2 of the element Si in the negative electrode active coating layer”.

This group of examples was carried out with reference to Examples 5a and 5d, respectively, except that c4/c2 was adjusted and controlled by changing c4, specifically as follows:
Example 10a was carried out with reference to Example 5a, except that c4 was 5437, and c4/c2 was 0.1812; and
Example 10b was carried out with reference to Example 5d, except that c4 was 916, and c4/c2 was 0.0057.

### Example 11

This example was used to verify the influence of “whether the second recesses were provided on the surface of positive electrode active coating layer on the first surface and whether the protrusions were provided on the surface of positive electrode active coating layer on the second surface”.

This example was carried out with reference to Example 1, except that an embossing treatment was carried out from the second surface to the first surface, that is, the surface of the positive electrode active coating layer on the second surface had second recesses, and the surface of the positive electrode active coating layer on the first surface had protrusions.

### Example 12

This example was used to verify the influence of “no second recesses and protrusions provided on the surface of the positive electrode active coating layer”.

This example was carried out with reference to Example 1, except that no embossing treatment was carried out.

### Example 13

This example was used to verify the influence of “whether the single-sided coated region had second recesses”.

This example was carried out with reference to Example 1, except that an embossing treatment was carried out on the single-sided coated region and the double-sided coated region (with the positive electrode tab welding region being avoided).

### Example 14 Group

This group of examples was used to verify the influence of the change of “w1, w2, w3, w4, and w5”.

This group of examples was carried out with reference to Example 1, except that w1, w2, w3, w4, and w5 were changed, specifically as follows:
in Example 14a, w1 was 0.5 mm, w2 was 2 mm, w3 was 2 mm, w4 was 0.5 mm, and w5 was 0.5 mm; and
in Example 14b, w1 was 10 mm, w2 was 40 mm, w3 was 25 mm, w4 was 20 mm, and w5 was 20 mm.

### Example 15

This example was used to verify the influence of the change of “the sphericity s of the primary spherical particles”.

This example was carried out with reference to Example 1, except that s was 0.72.

### Example 16

This example was used to verify the influence of the change of “the type of the first recesses”.

This example was carried out with reference to Example 1, except that recessed holes were made on the surface of the negative electrode plate by laser, wherein the recessed holes had a width of 80.1 μm, a depth of 25.3 μm, and a spacing of 0.5 mm; and g x s was 0.435.

### Example 17 Group

This group of examples was used to verify the influence of the change of “the proportion of the number of the primary spherical particles relative to the total number of the primary spherical particles and the secondary spherical particles”.

This group of examples was carried out with reference to Example 1, except that the proportion of the number of the primary spherical particles was changed, specifically as follows:
in Example 17a, the silicon-carbon material is entirely made up of primary spherical particles, that is, the proportion of the number of the primary spherical particles relative to the total number of the primary spherical particles and the secondary spherical particles was 1;
in Example 17b, the proportion of the number of the primary spherical particles relative to the total number of the primary spherical particles and the secondary spherical particles was 0.13; and
in Example 17c, the proportion of the number of the primary spherical particles relative to the total number of the primary spherical particles and the secondary spherical particles was 0.88.

### Example 18

This example was carried out with reference to Example 1, except that the artificial graphite was primary particles, and the average particle size was 6.1 μm.

### Example 19 Group

This group of examples was used to verify the influence of the change of “the mass content c3 of HTCN in the electrolyte”.

This group of examples was carried out with reference to Example 1, except that c3 was changed, specifically as follows:
in Example 19a, c3 was 0.5% and c2/c3 was 12; and
in Example 19b, c3 was 5% and c2/c3 was 1.2.

### Example 20 Group

This group of examples was used to verify the influence of the change of “the OI value of the negative electrode active coating layer”.

This group of examples was carried out with reference to Example 1, except that the OI value of the negative electrode active coating layer was adjusted and controlled by changing the average particle size of the secondary particles of the graphite material, specifically as follows:
in Example 20a, the OI value of the negative electrode active coating layer was 10.2; and
in Example 20b, the OI value of the negative electrode active coating layer was 29.9.

The above examples all satisfied the following conditions: the average particle size of the first particles of lithium cobalt oxide was 0.3-7 μm, and the average particle size of the second particles of lithium cobalt oxide was 7.5-40 μm. All of the above examples, except for Example 18, satisfy: the average particle size of the secondary particles of the graphite material was 6-20 μm. All of the above examples, except for Example 17a, satisfy: the average particle size of the secondary spherical particles of the silicon-carbon material was 3-20 μm. In all the above examples, except for Example 12, the protrusions satisfy: a height of 3-40 μm, a width of 0.2-8 mm, and a spacing of 0.5-8 mm.

### Comparative Example 1 Group

This group of comparative examples was used to verify the influence of the change of “the mass content c1 of the element Al in the positive electrode active coating layer”.

This group of comparative examples was carried out with reference to Example 1, except that c1 was changed, specifically as follows:
in Comparative Example 1a, c1 was 5271 ppm; and
in Comparative Example 1b, c1 was 18350 ppm.

### Comparative Example 2

This group of comparative examples was used to verify the influence of the change of “the mass content c2 of the element Si in the negative electrode active coating layer”.

This comparative example was carried out with reference to Example 1, except that, artificial graphite, a silicon-carbon material, a negative electrode conductive agent, a negative electrode dispersant, and a negative electrode binder were mixed in a mass ratio of 45:50:0.4:0.1:2.5; wherein c2 was 22.5%.

### Comparative Example 3 Group

This group of comparative examples was used to verify the influence of the change of “the average particle size d1 of the primary spherical particles”.

This group of comparative examples was carried out with reference to Example 1, except that the average particle size d1 of the primary spherical particles was changed, specifically as follows:
in Comparative Example 3a, d1 was 0.8 μm; and
in Comparative Example 3b, d1 was 6.5 μm.

### Comparative Example 4 Group

This group of comparative examples was used to verify the influence of the change of “the ratio c2/c3 of the mass content c2 of the element Si in the negative electrode active coating layer to the mass content c3 of HTCN in the electrolyte”.

This group of comparative examples was carried out with reference to Examples 5a and 5b, respectively, except that c2/c3 was adjusted and controlled by changing c3, specifically as follows:
Comparative Example 4a was carried out with reference to Example 5a, except that c3 was 5%, and c2/c3 was 0.6; and
Comparative Example 4b was carried out with reference to Comparative Example 5b, except that c3 was 0.5%, and c2/c3 was 22.

### Test Example

### (1) Volumetric Energy Density Test

The batteries prepared in the examples and comparative examples were subjected to a volumetric energy density test, and the specific test method was as follows:

the battery was charged to the charge cut-off voltage (4.48 V) at a current of 0.2 C, then charged at a constant voltage until the current dropped to 0.02 C, and then discharged to 3.0 V at a current of 0.2 C, and the discharge energy was recorded as E; and the thickness, width, and length of the battery were measured, the product of the three was calculated, and the volume of the battery was recorded as V. The formula for calculating the volumetric energy density was VED=E/V, and the results were reported in Table 1.

### (2) High-Temperature Cycling Test at 45° C.

The batteries prepared in the examples and comparative examples were subjected to a high-temperature cycling test at 45° C., and the specific test method was as follows:
the battery was left to stand in a constant-temperature room at 45° C. for 2 h, charged to 4.2 V at 3.5 C in a constant-current manner, and then charged to 4.48 V at 2 C in a constant-current and constant-voltage manner, the charging process was stopped at 0.05 C, and the battery was left to stand for 10 min; and the battery was then discharged to 3.0 V at 0.7 C, and this process was repeated in this way for 500 cycles. The thickness of the battery at full charge after the 500th cycle was measured as h1, with a discharge capacity being C1. The thickness of the battery at full charge after the 1st cycle was measured as h0, with a discharge capacity being CO. Thus, the capacity retention rate after 500 cycles was calculated as C1/C0, and the thickness expansion rate after 500 cycles was calculated as (h1−h0)/h0. The results are recorded in Table 1.

### (3) Fast-Charging Test

The batteries prepared in the examples and comparative examples were subjected to a fast-charging test, and the specific test method was as follows:

the battery was placed in a constant-temperature oven at 25° C. for 2 hours, then discharged at a constant current of 0.2 C to 3.4 V and left to stand for 5 min; and the battery was then charged at a constant current of 3.5 C to 4.2 V, at a constant current of 2.5 C to 4.25 V, and at a constant current of 2 C to 4.48 V (with a 1.2 C cutoff). The time required to charge the battery to 4.2 V at a constant current of 3 C was recorded (the longer the time, the better the fast-charging performance). The Land test system was set to record time at a sampling interval of 1s. The results are recorded in Table 1.

TABLE 1

| | Energy | Capacity | Thickness | |
|---|---|---|---|---|
| | density | retention | expansion | Fast-charging |
| | (Wh/L) | rate | rate | time (min) |
| Example 1 | 805 | 85.5% | 12.0% | 2.8 |
| Example 2 | 808 | 83.4% | 13.7% | 2.7 |
| Example 3 | 800 | 88.6% | 11.5% | 2.8 |
| Example 4a | 809 | 83.2% | 13.5% | 2.8 |
| Example 4b | 796 | 88.8% | 11.2% | 2.7 |
| Example 5a | 775 | 90.5% | 10.2% | 2.8 |
| Example 5b | 835 | 77.2% | 17.9% | 1.7 |
| Example 5c | 745 | 91.5% | 9.5% | 3 |
| Example 5d | 855 | 75.2% | 19.9% | 1.1 |
| Example 6a | 808 | 84.8% | 13.4% | 2.5 |
| Example 6b | 802 | 85% | 12.9% | 2.4 |
| Example 7a | 774 | 90.9% | 9.8% | 2.7 |
| Example 7b | 833 | 75.9% | 18.7% | 1.9 |
| Example 8a | 785 | 84.7% | 12.6% | 2.8 |
| Example 8b | 800 | 85.1% | 12.4% | 2.7 |
| Example 9a | 790 | 82.5% | 14.5% | 2.9 |
| Example 9b | 807 | 85.8% | 11.8% | 2 |
| Example 10a | 782 | 91% | 9.8% | 2.3 |
| Example 10b | 840 | 72.2% | 22.3% | 1.3 |
| Example 11 | 804 | 85% | 12.5% | 2.3 |
| Example 12 | 802 | 82.7% | 14.5% | 2 |
| Example 13 | 803 | 84.1% | 12.7% | 2.8 |
| Example 14a | 805 | 84.2% | 12.5% | 2.8 |
| Example 14b | 802 | 83.7% | 13.5% | 2.2 |
| Example 15 | 802 | 84.8% | 13.2% | 2.4 |
| Example 16 | 805 | 85.8% | 14.1% | 2.9 |
| Example 17a | 808 | 82.8% | 16.5% | 2.9 |
| Example 17b | 804 | 84.5% | 11.7% | 2.7 |
| Example 17c | 808 | 83.9% | 13.9% | 2.9 |
| Example 18 | 803 | 85.9% | 13.5% | 2.9 |
| Example 19a | 805 | 81.4% | 14.9% | 2.7 |
| Example 19b | 805 | 85.9% | 12.0% | 2.1 |
| Example 20a | 806 | 84.9% | 12.5% | 2.1 |
| Example 20b | 802 | 85.9% | 13.5% | 2.9 |
| Comparative | 807 | 80.5% | 15.7% | 2.6 |
| Example 1a | | | | |
| Comparative | 790 | 88.8% | 11.4% | 2.8 |
| Example 1b | | | | |
| Comparative | 860 | 70.2% | 25.3% | 0.7 |
| Example 2 | | | | |
| Comparative | 809 | 82.8% | 14.9% | 1.6 |
| Example 3a | | | | |
| Comparative | 795 | 85% | 13.4% | 2.2 |
| Example 3b | | | | |
| Comparative | 770 | 90.5% | 15.2% | 2 |
| Example 4a | | | | |
| Comparative | 835 | 70.2% | 23.9% | 1.7 |
| Example 4b | | | | |

As can be seen from Table 1, compared with the comparative examples, the batteries of the present disclosure have a high energy density, excellent cycling stability, and a fast-charging capability.

The preferred embodiments of the present disclosure have been described in detail above; however, the present disclosure is not limited thereto. Within the technical concept of the present disclosure, various simple modifications can be made to the technical solution of the present disclosure, including the combination of various technical features in any other suitable way. These simple modifications and combinations should also be regarded as the content disclosed by the present disclosure and all fall within the scope of protection of the present disclosure.

What is claimed is:

1. A lithium-ion secondary battery, comprising a positive electrode plate, a negative electrode plate, and an electrolyte, wherein the lithium-ion secondary battery has a charge cut-off voltage of ≥4.48 V;
the positive electrode plate comprises a positive electrode active coating layer, the positive electrode active coating layer comprises a positive electrode active material, the positive electrode active material comprises lithium cobalt oxide, and the lithium cobalt oxide contains the element Al, with the mass content c1 of the element Al in the positive electrode active coating layer being 6000-15000 ppm;
the negative electrode plate comprises a negative electrode active coating layer, the negative electrode active coating layer comprises a negative electrode active material, and the negative electrode active material comprises a silicon-carbon material, wherein the mass content c2 of the element Si in the negative electrode active coating layer is 1.5-16%; and the silicon-carbon material comprises primary spherical particles with an average particle size of 1-6 μm; and
the electrolyte comprises 1,3,6-hexanetricarbonitrile, with
the mass content c3 of the 1,3,6-hexanetricarbonitrile in the electrolyte and the mass content c2 of the element Si in the negative electrode active coating layer satisfying:
$$0.63 \leq c 2 / c 3 \leq 15 .$$

2. The lithium-ion secondary battery according to claim 1, wherein the mass content c1 of the element Al in the positive electrode active coating layer is 6500-12000 ppm.

3. The lithium-ion secondary battery according to claim 2, wherein the mass content c2 of the element Si in the negative electrode active coating layer is 3-11%.

4. The lithium-ion secondary battery according to claim 2, wherein the average particle size of the primary spherical particles is 3-5 μm.

5. The lithium-ion secondary battery according to claim 2, wherein the silicon-carbon material comprises a material formed by filling pores of a porous carbon with silicon and/or oxidized silicon.

6. The lithium-ion secondary battery according to claim 2, wherein the mass content of the element Si in the silicon-carbon material is 30-80%.

7. The lithium-ion secondary battery according to claim 1, wherein the positive electrode active coating layer further comprises a lithium-supplementing agent.

8. The lithium-ion secondary battery according to claim 7, wherein the lithium-supplementing agent comprises a material with a chemical formula of Li₅₊ₓFe_{y}M¹_{z}O₄ and/or a material with a chemical formula of Li_{2±a}Ni_{b}M²_{c}O₂, where −0.5≤x≤5, 0.8≤y≤1.2, 0≤z≤1, and M¹ comprises at least one of Mo, Nb, Ti, Zr, Ni, Y, Mn, Cu, Mg and Zn; 0≤a≤0.5, 0≤b≤1, and 0≤c≤1; and M² comprises at least one of Mo, Nb, Ti, Zr, Fe, Y, Mn, Cu, Mg and Zn.

9. The lithium-ion secondary battery according to claim 8, the mass content c4 of the element M¹ and/or the element M² in the positive electrode active coating layer is 900-7000 ppm, more preferably, 1600-6000 ppm.

10. The lithium-ion secondary battery according to claim 4, wherein c4 and the mass content c2 of the element Si in the negative electrode active coating layer satisfy: 0.005≤c4/c2≤0.19.

11. The lithium-ion secondary battery according to claim 1, wherein the negative electrode active coating layer has an OI value of 10-30.

12. The lithium-ion secondary battery according to claim 11, wherein the primary spherical particles have a sphericity s of 0.7-1.

13. The lithium-ion secondary battery according to claim 1, wherein an outer surface of the negative electrode active coating layer has first recesses, and a spacing g between the first recesses and the sphericity s of the primary spherical particles satisfy: 0.4≤g×s≤2, with the spacing g between the first recesses being in mm.

14. The lithium-ion secondary battery according to claim 13, wherein the spacing g between the first recesses is 0.5-5 mm;
and a depth of the first recesses is 5-40 μm;
and a width of the first recesses is 40-200 μm.

15. The lithium-ion secondary battery according to claim 1, wherein the silicon-carbon material further comprises a plurality of secondary spherical particles formed from the primary spherical particles;
the secondary spherical particles have an average particle size of 3-20 μm;
a proportion of the number of the primary spherical particles in the negative electrode active coating layer relative to the total number of the primary spherical particles and the secondary spherical particles is 0.1-0.9; and
the negative electrode active material further comprises a graphite material.

16. The lithium-ion secondary battery according to claim 1, wherein the positive electrode plate comprises a positive electrode current collector and the positive electrode active coating layer provided on a surface on at least one side of the positive electrode current collector; a length of the positive electrode active coating layer on a first surface of the positive electrode current collector is greater than a length of the positive electrode active coating layer on a second surface of the positive electrode current collector;
a region where a projection of the positive electrode active coating layer on the first surface overlaps with a projection of the positive electrode active coating layer on the second surface in the thickness direction of the positive electrode plate is a double-sided coated region, and a region where the projections do not overlap is a single-sided coated region;
a surface of the positive electrode active coating layer on the first surface has second recesses, and a surface of the positive electrode active coating layer on the second surface has protrusions;
the positive electrode plate comprises a positive electrode tab welding region, a pasted region, and an uncoated foil region, and the second recesses and the protrusions are provided in the pasted region;
the positive electrode plate comprises a pasted region, the pasted region comprises the double-sided coated region and the single-sided coated region, and the second recesses and the protrusions are provided in the double-sided coated region.

17. The lithium-ion secondary battery according to claim 16, wherein
a depth of the second recesses is 3-40 μm, a width of the second recesses is 0.2-8 mm, and a spacing between the second recesses is 0.5-8 mm; and
a height of the protrusions is 3-40 μm, a width of the protrusions is 0.2-8 mm, and a spacing between the protrusions is 0.5-8 mm.

18. The lithium-ion secondary battery according to claim 16, wherein the positive electrode plate comprises a positive electrode tab welding region, a pasted region, and an uncoated foil region, and the pasted region comprises the double-sided coated region and the single-sided coated region;
a distance from the second recesses to an edge of the positive electrode tab welding region is w1, with 0 mm<w1≤10 mm; and
a distance from the second recesses to an edge of a first side of the pasted region is w2, with 2 mm≤w2≤40 mm, and the first side is a side where the positive electrode tab welding region is provided.

19. The lithium-ion secondary battery according to claim 16, wherein
a distance from the second recesses to an edge of a second side of the pasted region is w3, with 2 mm≤w3≤25 mm, and the second side is a side opposite to the side where the positive electrode tab welding region is provided; and
a distance from the second recesses to an edge of a third side of the pasted region is w4, with 0 mm<w4≤20 mm, and the third side is a side of the pasted region close to a winding head end.

20. The lithium-ion secondary battery according to claim 16, wherein
a distance from the second recesses to a boundary line between the double-sided coated region and the single-sided coated region is w5, with 0 mm<w5≤20 mm.
